(19) United States
(12) Patent Application Publication
(10) Pub. No.: US 2014/0372886 A1
(43) Pub. Date: Dec. 18, 2014

(54) PROVIDING HELP ON VISUAL COMPONENTS DISPLAYED ON TOUCH SCREENS

(71) Applicant: Oracle International Corporation, Redwood Shores, CA (US)

(72) Inventor: SUBRAMANIAM RAMASUBRAMANIAN, Chennai (IN)

(21) Appl. No.: 13/917,672

(22) Filed: Jun. 14, 2013

(51) Int. Cl. G06F 3/0488

(52) U.S. Cl. CPC G06F 3/0488
USPC 715/705

(57) ABSTRACT

An aspect of the present disclosure provides help on visual components of interest displayed on a touch screen. In an embodiment, a help icon is displayed along with visual components generated for interaction with an application. The user is permitted to associate the help icon with a visual component of interest (for example, by dragging and dropping the help icon on the visual component), and help passage associated with the visual component is displayed as a response. As the user can accurately indicate the visual components of interest, the relevant help passages can be accurately identified and displayed.

### BACKGROUND

1. Technical Field

The present disclosure relates generally to computer systems, and more specifically to providing help on components displayed on display screen.

2. Related Art

Touch screens are often seen employed in devices such as mobile phones, personal digital assistants, point of sale (POS) terminals, etc. A touch screen generates signals (touch signals) responsive to touch/pressure on the display screen, with the signals forming the basis for providing suitable user interfaces. For example, selection of a URL may be indicated by a simple tap on a hyperlink displayed on a touch screen. Similarly, pinching, persistent touch, scrolling, etc., are also some of the commonly used touch operations associated with touch screens.

Visual components are often displayed on touch screens, forming the basis for a suitable user interface. A visual component is any distinct portion identifiable as a separate displayed entity. Examples of visual components include various graphical icons, blocks, etc., having some distinct boundaries, as clearly perceivable by the human eye. The visual components serve functions such as representing portions of a physical product, as invocation points for corresponding functions provided by an application rendering the display, etc.

There is a general need to provide help associated with various visual components displayed on touch screens. Help generally provides information on the details (e.g., information, manner of usage, etc.) of the corresponding component.

### BRIEF DESCRIPTION OF THE DRAWINGS

Example embodiments of the present disclosure will be described with reference to the accompanying drawings briefly described below.

FIG. 1 is a block diagram illustrating an example special purpose digital computing system in which several aspects of the present disclosure can be implemented.

FIG. 2 is flowchart illustrating the manner in which help is provided on visual components displayed on a touch screen, in an embodiment of the present disclosure.

FIGS. 3-5 are diagrams of an example user interface using which help is provided on visual components in an embodiment.

FIG. 6 is a diagram depicting the organization of help passages corresponding to various visual components of an example user interface, in an embodiment.

FIGS. 7-8 are diagrams of an example user interface using which help is provided on visual components in an embodiment.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

1. Overview

An aspect of the present disclosure provides help on visual components of interest displayed on a touch screen. In an embodiment, a help icon is displayed along with visual components generated for interaction with an application. The user is permitted to associate the help icon with a visual component of interest (for example, by dragging and dropping the help icon on the visual component), and help passage associated with the visual component is displayed as a response.

As the user can accurately indicate the visual components of interest, the relevant help passages can be accurately identified and displayed. According to another aspect, only the help passage corresponding to the specific visual component of interest is displayed when such passage is available associated with the visual component.

According to yet another aspect, the visual components are displayed in a hierarchy for convenient interaction by a user. In case a user selects a visual component at a lower level, and there is no corresponding help passage for the component, the help passages corresponding to only the higher level component and the sub-components of the higher level component are searched for suitable text to display. The corresponding matching text is displayed for the help passage, as a response.

Several aspects of the present disclosure are described below with reference to examples for illustration. However, one skilled in the relevant art will recognize that the disclosure can be practiced without one or more of the specific details or with other methods, components, materials and so forth. In other instances, well-known structures, materials, or operations are not shown in detail to avoid obscuring the features of the disclosure. Furthermore, the features/aspects described can be practiced in various combinations, though only some of the combinations are described herein for conciseness.

2. Example System

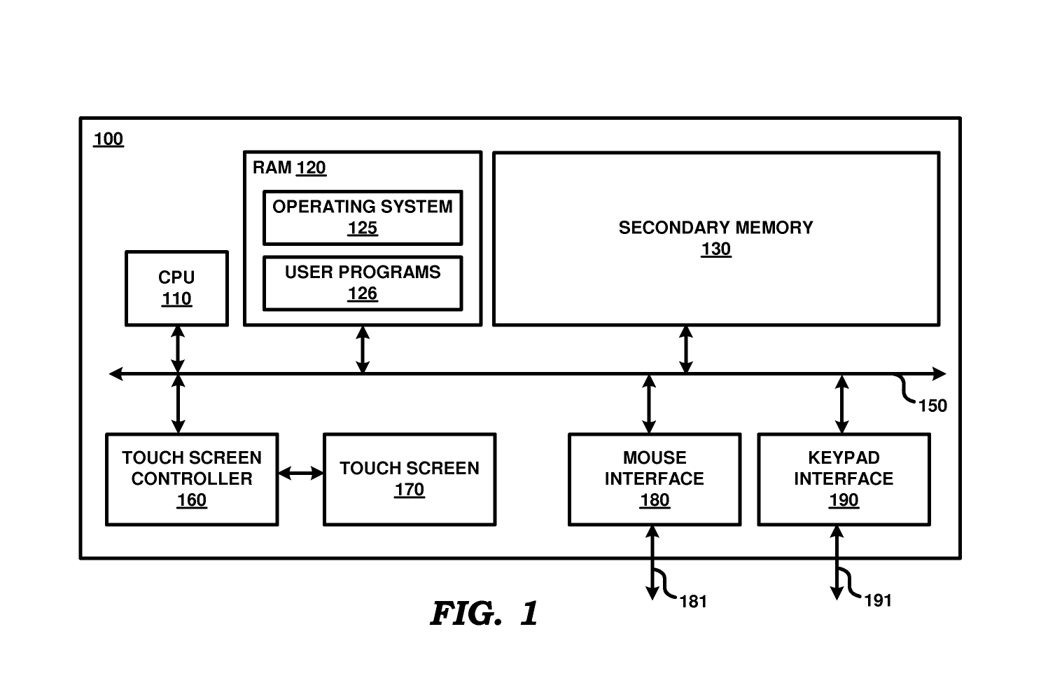

FIG. 1 is a block diagram illustrating the details of an example special purpose computing system in which several aspects of the present disclosure can be implemented. Special purpose computing system (System) 100, which may for example correspond to a personal digital assistant (PDA), a mobile phone, etc., is shown containing central processing unit (CPU) 110), random access memory (RAM) 120, secondary memory 130, touch screen controller 160, touch screen 170, mouse interface 180 and keypad interface 190. All the components except touch screen 170 may communicate with each other over communication path 150, which may contain several buses as is well known in the relevant arts.

CPU 110 may execute instructions stored in RAM 120 to provide various features of system 100. Thus, for example, when system 100 corresponds to a PDA, the operation of CPU 110 may enable a user to use one or more of many user applications stored in the PDA and executable by CPU 110. The applications may include, for example, word processors, web browsers, email client, data organizers such as address books, etc. CPU 110 may contain multiple processing units, with each processing unit potentially being designed for a specific task. Alternatively, CPU 110 may contain only a single general-purpose processing unit.

RAM 120 may receive instructions from secondary memory 130 using communication path 150. RAM 120 is shown currently containing software instructions constituting shared environment 125 and user programs 126. Shared environment 125 contains utilities shared by user programs 126, and such shared utilities include operating system, device drivers, etc., which provide a (common) run-time environment for execution of user programs/applications. User programs 126 may include applications such as word processing, email client, etc., noted above. One or more of user programs 126 may be designed to interact with a user via a graphical user interface (GUI) presented on touch screen 170, described below.

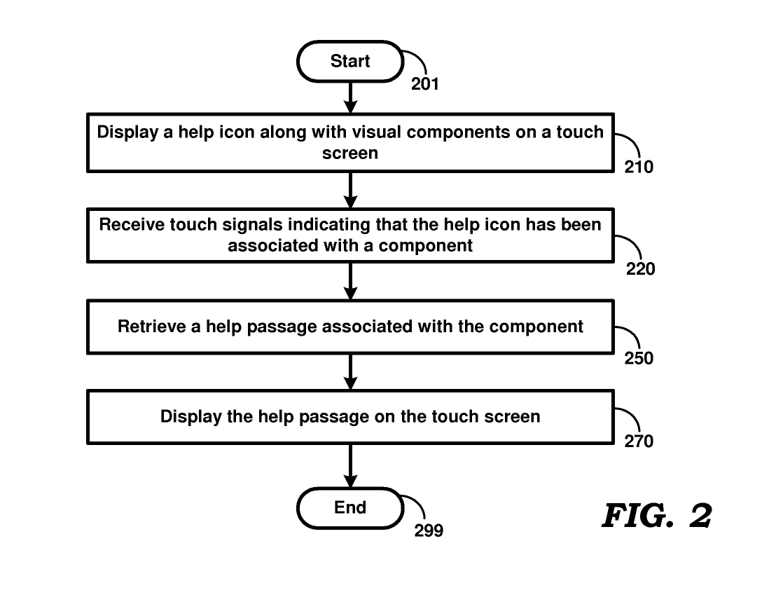

Secondary memory 130 represents a non-transitory machine readable storage medium, and may store data and software instructions (for example, for performing the steps of the flowchart of FIG. 2, described below), which enables system 100 to provide several features in accordance with the present disclosure. Further, secondary memory 130 may store data representing various ‘help passages’ corresponding to an application executed by CPU 110. Secondary memory 130 may be implemented using one or several non-volatile memory technologies such as flash memory. The code/instructions stored in secondary memory 130 may either be copied to RAM prior to execution by CPU 110 for higher execution speeds, or may be directly executed by CPU 110.

Mouse interface 180 enables user-inputs to be provided to system 100 via a mouse (not shown) connected on path 181. Keypad interface 190 is connected to a keypad (not shown) via path 191, and enables user-inputs to be provided to system 100 via a keypad.

Touch screen controller 160 generates display signals (e.g., in RGB format) to cause corresponding text or images (for example, in the form of a GUI) to be displayed on touch screen 170. Touch screen controller 160 receives touch signals generated by touch screen 170, in response to touch/pressure (in general, the touch operations) applied on touch screen 170. Touch screen controller 160 may process such touch signals and generate digital data representing the touch signals.

The generated digital data is passed to appropriate execution entities via the shared environment 125. For example, if a touch operation is performed with respect to a visual component controlled by a user application, the digital data is eventually delivered to the user application.

Touch screen 170 displays text/images, etc, defined by the display signals received from touch screen controller 160. Thus, touch screen 170 may display a GUI generated by an application executed by CPU 110. Touch screen 170 generates touch signals in response to touch operations using finger(s) or stylus, etc., with respect to a corresponding portion (for example a visual component) of touch screen 170. Touch screen controller 160 and touch screen 170 may be implemented in a known way.

A GUI displayed on touch screen 170 may include one or more visual components, as noted above. A user using the corresponding application generating the GUI may wish to obtain help on one or more of the visual components. The manner in which such help is provided is described next with respect to a flowchart.

3. Providing Help on Visual Components

FIG. 2 is flowchart illustrating the manner in which help is provided on visual components displayed on a touch screen, in an embodiment of the present disclosure. The steps in the flowchart are described with respect to the example system of FIG. 1, and in a specific sequence merely for illustration. Alternative embodiments in other devices/environments, and using a different sequence of steps can also be implemented without departing from the scope and spirit of several aspects of the present disclosure, as will be apparent to one skilled in the relevant arts by reading the disclosure provided herein. The flowchart starts in step 201, in which control passes immediately to step 210.

In step 210, a help icon is displayed along with visual components on a display screen. In the embodiments described below, the help icon corresponds to a graphical icon (another visual component). However, alternative embodiments can employ simpler (e.g., as simple as a line or a circle) or complex visual components, without departing from the scope and spirit of the present disclosure, as will be clear to one skilled in the relevant arts by reading the disclosure herein. As described below, the help icon is provided to enable a user to obtain help text/topics related to the other visual components displayed on the display screen.

In step 220, touch signals are received indicating that the help icon has been associated (by a user) with a displayed visual component. Any suitable conventions based on touch operations of users, can be employed for such association. In the example embodiments described below, a user is shown employing a drag and drop touch operation (where the first touch/tap represents the selection of the help icon and swiping continues until the help icon is dropped on the component of interest) for such an association. Such a convention requires only a single finger of a user. However, alternative conventions using multiple fingers, etc., can be employed in combination with the help icon, without departing from the scope and spirit of several aspects of the present disclosure.

In step 250, a help passage associated with the component is retrieved. Thus, help passages may be maintained for at least each of the displayed visual components, for which users are likely to seek help. When the user thereafter selects a displayed visual component by the association noted in step 220, the help passage corresponding to the associated displayed visual component is selected. The help passage for each visual component may represent information describing the component, its use or any other related information the user may be interested in.

In step 270, the retrieved help passage is displayed on the touch screen. The term display includes sending the corresponding command/data, which causes the eventual display to be caused on a display screen. The flowchart ends in step 299.

It may thus be appreciated that help is conveniently provided associated with visual components of interest using a help icon and the touch features present associated with the touch screen. In addition, since the intent of the user as to the specific visual component of interest is certain, relevant help passages can be displayed with a higher probability at least compared to text-based search approaches. The description is continued with respect to example user interface(s) implementing the approach noted above.

4. User Interface

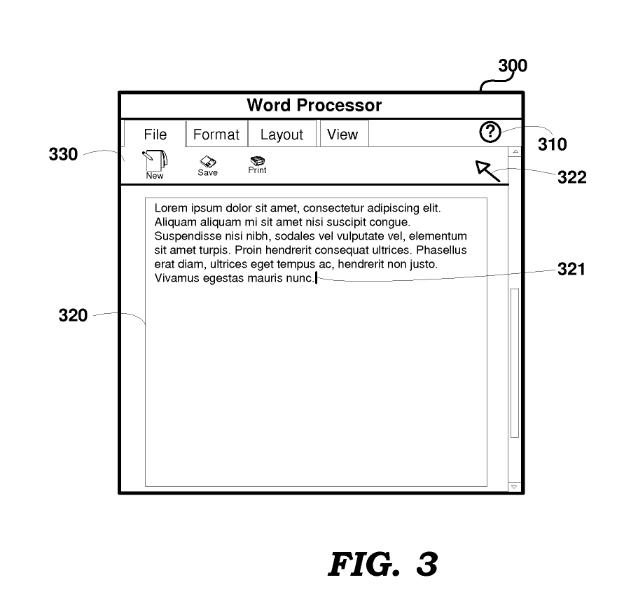

FIGS. 3-8 together depict an example user interface using which help is provided on visual components, in one embodiment. FIG. 3 depicts a simplified user interface 300 provided by a word processor application. User interface 300 is shown containing text edit area 320 and ribbon 330.

Text edit area 320 is shown containing text presently being edited by a user with the cursor and mouse pointer respectively shown at 321 and 322. As is well known, a cursor represents the position where any text inputs would be inserted (using keypad/board) and a mouse pointer represents the position pointed by the mouse. It should be appreciated that the embodiments of the present disclosure can be implemented in mobile phones/PDA type of devices, which may not have keyboard, mouse, etc., and the users of such devices can conveniently use the approaches described herein to seek help on the displayed visual components of interest.

Ribbon 330 is shown containing various tabs (examples of visual components) ‘File’, ‘Format’, ‘Layout’ and ‘View’, in addition to help icon 310. It may be observed that each visual component is designed for corresponding interaction by a user. The functions thus provided are organized hierarchically for convenient navigation by the user.

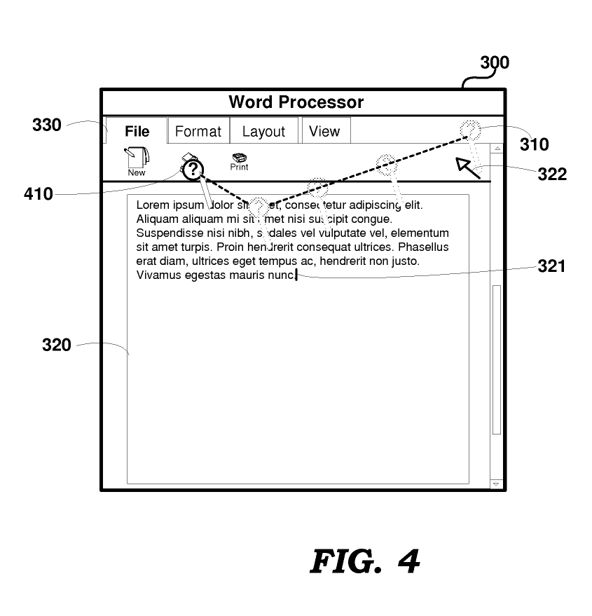

The ‘File’ tab (representing a visual component) is shown as having been selected and accordingly the sub-options ‘New’, ‘Save’ and ‘Print’ (all representing visual components as well) are also shown in the ribbon. It is now assumed that the user wishes to seek help on the ‘Save’ sub-option, and the manner in which the features of the present disclosure can be used for obtaining help is described below with respect to FIG. 4.

FIG. 4 represents the display as a user uses a drag-and-drop operation to associate the help icon with the ‘Save’ sub-option. The user performs a drag-and-drop operation by first placing a finger (or stylus, etc.) on help icon at 310 and dragging (i.e., maintaining continuous touch with the screen) the icon along the path shown until the icon is placed over the ‘Save’ sub-option, as shown at 410. The various positions of the icon along the drag and drop operation are shown along the dotted path.

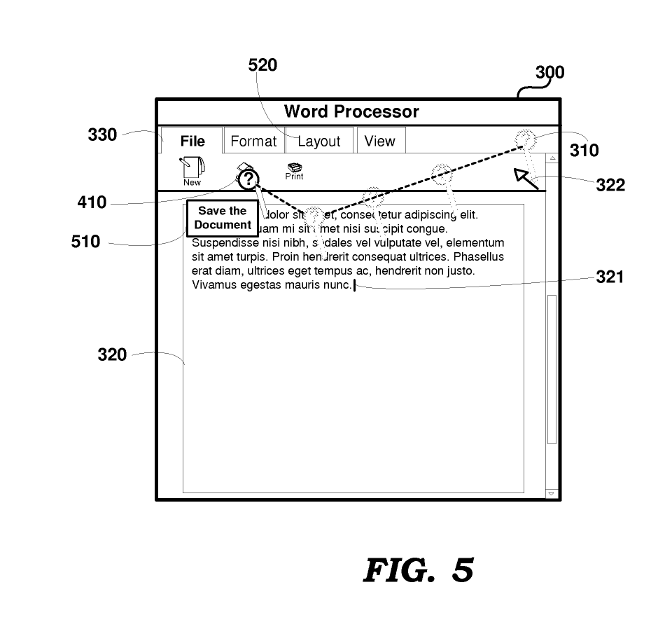

Upon completion of the dropping (i.e., finger being lifted) of icon 310, help message 510 is shown displayed in edit portion 320, as depicted in FIG. 5.

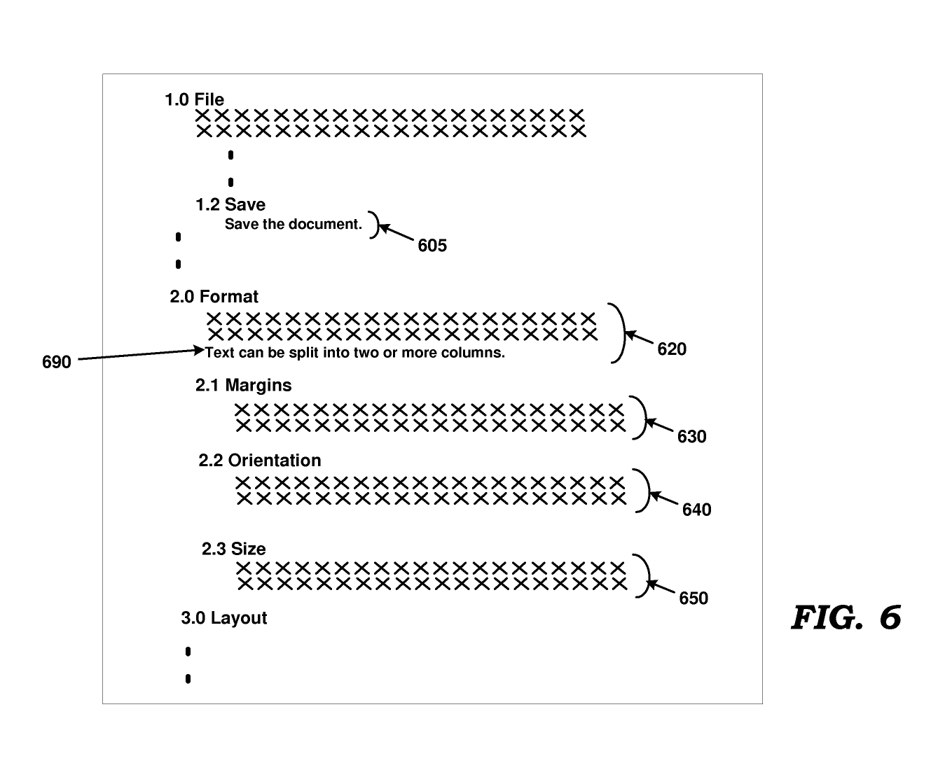

FIG. 6 depicts the organization of help passages corresponding to various visual components of GUI 300. The help passages available for some of the components of GUI 300 are shown. The help passages together may be viewed as a help text and thus the help passages are shown stored as successive portions of the help text.

Help passages 605, 620, 630, 640 and 650 are assumed to be tagged associated with visual components ‘Save’, ‘Format’, ‘Margins’, ‘Orientation’ and ‘Size’. Tagging implies storing some configuration data which indicates the specific help segment/text/passage is associated with a corresponding visual component. As described below, the last three visual components are sub-options of ‘Format’ tab. It may thus be appreciated that the help passages are conveniently organized matching the hierarchy of the associated visual component.

Thus, when ‘Save’ sub-option is selected in FIG. 4, system 100 examines the help text of FIG. 6 to retrieve help passage 605 (tagged associated with the sub-option ‘Save’), and display the contained text, as shown in FIG. 5. While the help information is shown in the form of only text, it should be appreciated other forms such as sound and video can also be employed for providing help, as suited in appropriate situations.

From the above, it may be appreciated that the help information provided is precise and relevant to what the user seeks, since the user is able to precisely indicate her/his visual component of interest, and the help passages are organized associated according to the respective components.

Furthermore, even if a ‘Save’ sub-option is available under some other option or sub-option (such as for example ‘Layout’ tab 520), and assuming that sub-option has a different help information, such information is not displayed in FIG. 6, thereby avoiding display of potentially irrelevant information. In general, it may be appreciated that only the help passage corresponding to the visual component of interest (and not the help passages for other visual components, even if similar labeled) is sent for display.

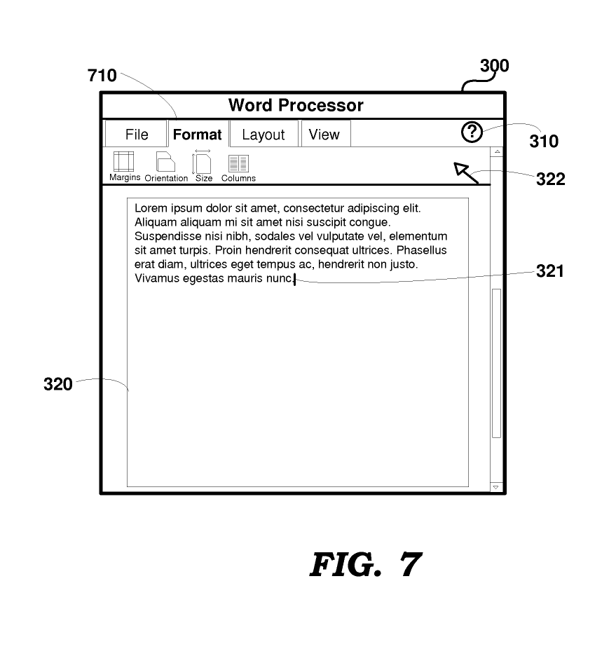

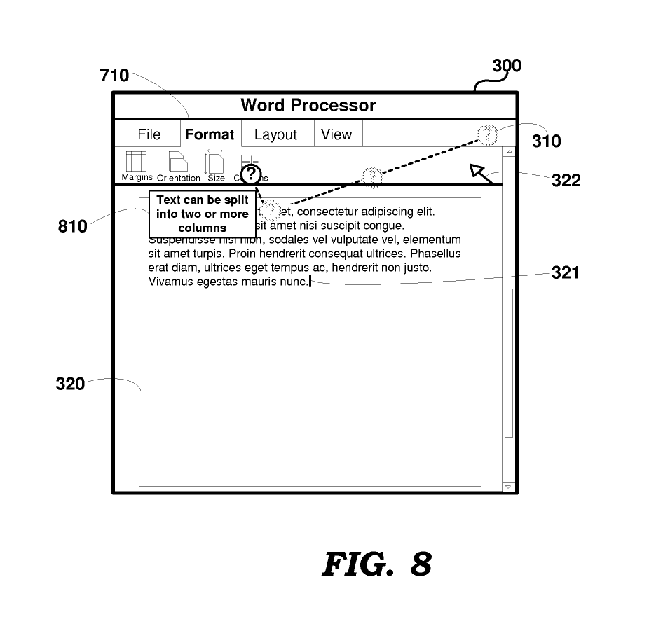

An aspect of the present disclosure provides help information even if a help passage is not explicitly tagged for a corresponding visual component. FIGS. 7 and 8 in combination with portions of FIG. 6 are used to illustrate the manner in which such help information is provided.

5. Providing Help On a Component That Does Not Have a Tagged Help Passage

FIG. 7 shows user interface 300, when the user has selected the ‘Format’ tab. The corresponding sub-options ‘Margins’, ‘Orientation’, ‘Size’ and ‘Columns’ are available for user-selection. It is assumed herein that there is no help passage tagged for visual component ‘Columns’ Correspondingly, FIG. 6 does not contain a help passage explicitly tagged for ‘Columns’, although it may be observed that help passages explicitly tagged for main option ‘Format’ and the other three sub-options ‘Margins, ‘Orientation’ and ‘Size’ exist, as indicated by help passages 620, 630, 640 and 650.

In FIG. 8, the user is shown as seeking help on the ‘Columns’ sub-option (i.e., ‘Columns’ is the visual component of interest), as indicated by the drag-and-drop of the help icon 310 on the ‘Columns’ sub-option.

According to an aspect of the present disclosure, when a help passage is not explicitly tagged for a component, system 100 determines if a parent component is present. A parent component is the component that is located immediately above (in hierarchy) the component for which help is sought in a corresponding hierarchy of components.

To illustrate, the ‘Format’ component in FIG. 7 may be observed as located immediately above the sub-option components ‘Orientation’, ‘Size’ and ‘Columns’, in the interface hierarchy. Thus, ‘Format’ may be viewed as a parent component, with ‘Orientation’, ‘Size’ and ‘Columns’ being the corresponding child components. Thus, system 100 determines ‘Format’ as being the parent component of ‘Columns’.

Having determined the parent component, system 100 performs a keyword search for the text ‘Column’, in a help portion starting from the help passage corresponding to the parent component (‘Format’ in the example) and ending with the help passage corresponding to the last child in the hierarchy. With respect to FIG. 6, system 100 starts the keyword search from the start of help passage 620 corresponding to ‘Format’, and obtains a match in the sentence/text indicated as 690.

System 100 then provides text 690 (“Text can be split into two or more columns ”) as the closest help passage/text for ‘Columns’, as indicated by 810 in FIG. 8. The specific location in FIG. 6 of text 690 is provided merely as an example, and text 690 may be located anywhere within the start of help passage 620 and the end of help passage 650.

Although a simple keyword search is noted above as being performed by system 100, system 100 may employ other/more complex techniques (e.g., based on various heuristics, etc.) to identify the help passage(s) to be provided for a component that does not have a tagged help passage. To enable identification of help passages for corresponding components, system 100 may maintain information specifying the hierarchies of the various components.

In an embodiment of the disclosure, a user application (e.g., the word processing application, described above) generates/specifies the various visual components and operating system 125 (part of the shared environment) adds help icon 310 to the visual display. Each visual component has an associated function/utility that can be obtained by selection of the corresponding visual component. Instructions of the user application are operative to provide the corresponding function/utility.

Thus, the features described above can be implemented with respect to any of the user applications, as suitable in corresponding environments. In addition, the features can be implemented in the context of the operating system as well (with the help icon being displayed in addition to various desk top icons otherwise displayed, as an example). It may thus be appreciated that the help icon is displayed in addition to the various visual component generated for interaction with the corresponding application.

6. Conclusion

While various embodiments of the present disclosure have been described above, it should be understood that they have been presented by way of example only, and not limitation. Thus, the breadth and scope of the present disclosure should not be limited by any of the above-described exemplary embodiments, but should be defined only in accordance with the following claims and their equivalents.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

It should be understood that the figures and/or screen shots illustrated in the attachments highlighting the functionality and advantages of the present disclosure are presented for example purposes only. The present disclosure is sufficiently flexible and configurable, such that it may be utilized in ways other than that shown in the accompanying figures.

Further, the purpose of the following Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present disclosure in any way.

What is claimed is:

1. A method of providing help on visual components of interest displayed on a touch screen, wherein said method is performed in a digital processing system containing said touch screen, said method comprising:
sending for display a help icon along with a plurality of visual components on said touch screen;
receiving one or more touch signals indicating that said help icon has been associated with a visual component of interest;
retrieving a help passage associated with the visual component of interest; and
sending for display said help passage on said touch screen.

2. The method of claim 1, wherein said one or more touch signals are received upon a user action of dragging-and-dropping of said help icon on said component of interest.

3. The method of claim 1, wherein said visual components are provided as part of a graphical user interface generated by a user application executed on said system, wherein only said plurality of visual components are generated by said user application and said help icon is added for display on said touch screen by an operating system.

4. The method of claim 1, further comprising:
maintaining a plurality of help passages in a memory, each associated with a respective visual component of said plurality of visual components,
wherein said retrieving retrieves the help passage from said memory prior to sending said help message for display.

5. The method of claim 4, wherein said visual components are displayed according to a hierarchy such that a first component is a parent to a set of child components, each of the child components corresponding to a sub-option of a higher level option represented by said parent,
wherein said maintaining stores help passages associated with said first component and some of said set of child components,
wherein a second component representing one of said set of child components corresponds to said visual component of interest.

6. The method of claim 5, wherein a first help passage is stored associated with said second component, and only said first help passage among all help passages maintained for said visual components, is sent for display as a response to said help icon having been associated with said second component.

7. The method of claim 5, wherein said second visual component does not have an associated help passage, said method further comprising:
examining the help passages corresponding to said parent and said set of child components to identify a closest help text for said second component; and
sending the closest help text as said help passage for display on the touch screen.

8. The method of claim 5, wherein the help passages corresponding to said parent and said set of child components are stored as successive portions of a help text.

9. A non-transitory machine readable storage medium storing one or more sequences of instructions for enabling a digital processing system to provide help on visual components of interest displayed on a touch screen in said digital processing system, wherein execution of said one or more instructions by one or more processors contained in said digital processing system causes said digital processing system to perform the actions of:
sending for display a help icon along with a plurality of visual components on said touch screen;
receiving one or more touch signals indicating that said help icon has been associated with a visual component of interest;
retrieving a help passage associated with the visual component of interest; and
sending for display said help passage on said touch screen.

10. The non-transitory machine readable storage medium of claim 9, wherein said one or more touch signals are received upon a user action of dragging-and-dropping of said help icon on said component of interest.

11. The non-transitory machine readable storage medium of claim 9, wherein said visual components are provided as part of a graphical user interface generated by a user application executed on said system, wherein only said plurality of visual components are generated by said user application and said help icon is added for display on said touch screen by an operating system.

12. The non-transitory machine readable storage medium of claim 1, further comprising instructions for maintaining a plurality of help passages in a memory, each associated with a respective visual component of said plurality of visual components,
wherein said retrieving retrieves the help passage from said memory prior to sending said help message for display.

13. The non-transitory machine readable storage medium of claim 12, wherein said visual components are displayed according to a hierarchy such that a first component is a parent to a set of child components, each of the child components corresponding to a sub-option of a higher level option represented by said parent,
wherein said maintaining stores help passages associated with said first component and some of said set of child components,
wherein a second component representing one of said set of child components corresponds to said visual component of interest.

14. The non-transitory machine readable storage medium of claim 13, wherein a first help passage is stored associated with said second component, and only said first help passage among all help passages maintained for said visual components, is sent for display as a response to said help icon having been associated with said second component.

15. The non-transitory machine readable storage medium of claim 13, wherein said second visual component does not have an associated help passage, said non-transitory machine readable storage medium further comprising instructions for:
examining the help passages corresponding to said parent and said set of child components to identify a closest help text for said second component; and
sending the closest help text as said help passage for display on the touch screen.

16. The non-transitory machine readable storage medium of claim 13, wherein the help passages corresponding to said parent and said set of child components are stored as successive portions of a help text.

17. A digital processing system comprising:
a touch screen;
a memory; and
a processor
wherein said processor to retrieve instructions from said memory and execute the retrieved instructions, causing said digital processing system to perform the actions of:
send for display a help icon along with a plurality of visual components on said touch screen;
receive one or more touch signals from said touch screen indicating that said help icon has been associated with a visual component of interest;
retrieve, from said memory, a help passage associated with the visual component of interest; and
sending for display said help passage on said touch screen.

18. The digital processing system of claim 17, wherein said one or more touch signals are received upon a user action of dragging-and-dropping of said help icon on said component of interest.

19. The digital processing system of claim 18, wherein said visual components are provided as part of a graphical user interface generated by a user application executing in said digital processing system, wherein only said plurality of visual components are generated by said user application and said help icon is added for display on said touch screen by an operating system executing on said digital processing system.

20. The digital processing system of claim 18, wherein said visual components are displayed according to a hierarchy such that a first component is a parent to a set of child components, each of the child components corresponding to a sub-option of a higher level option represented by said parent,
wherein said maintaining stores help passages associated with said first component and some of said set of child components,
wherein a second component representing one of said set of child components corresponds to said visual component of interest,
wherein a first help passage is stored associated with said second component, and only said first help passage among all help passages maintained for said visual components, is sent for display as a response to said help icon having been associated with said second component.
